(19) United States
(12) Patent Application Publication
(10) Pub. No.: US 2023/0292140 A1
(43) Pub. Date: Sep. 14, 2023

(54) METHOD OF DETERMINING LOCATION FOR INSTALLING MOVEABLE BASE STATION AND DETERMINING ACCESS-POINT BASE STATION, AND INFORMATION PROCESSING APPARATUS

(71) Applicant: NIPPON TELEGRAPH AND TELEPHONE CORPORATION, Tokyo (JP)

(72) Inventors: Toshiro NAKAHIRA, Tokyo (JP); Motoharu SASAKI, Tokyo (JP); Koichi ISHIHARA, Tokyo (JP); Takatsune MORIYAMA, Tokyo (JP); Yasushi TAKATORI, Tokyo (JP)

(21) Appl. No.: 18/005,993

(22) PCT Filed: Aug. 25, 2020
(86) PCT No.: PCT/JP2020/031960

§ 371 Date: Jan. 19, 2023

(51) Int. Cl. H04W 16/18; H04B 17/318

(52) U.S. Cl. CPC H04W 16/18; H04B 17/328

(57) ABSTRACT

A determination method of determining an installation position of a movable base station and a connection destination base station, executed by an information processing device including a memory and a processor, includes: determining a mesh in which the movable base station can be installed, and a base station to which the movable base station can be connected in the mesh, based on a reception strength of a radio signal from each of one or more base stations in each of one or more meshes.

### TECHNICAL FIELD

The present disclosure relates to a determination method of an installation position of a movable base station and a base station that is a connection destination, and an information processing apparatus.

### BACKGROUND ART

As wireless terminals including smartphones and tablets have rapidly been distributed in recent years, the number of users of such wireless terminals who use large-volume content have suddenly increased and the volume of traffic on wireless networks has been rapidly increasing. The IEEE 802.11 wireless LAN standard described in NPL 1, which is widely used as a high-speed wireless access system using radio waves in a band for which no license for a wireless system is required, is often used to easily accommodate radio traffic at a low cost. Wireless LAN networks are provided in various areas including private areas such as homes, offices, and public areas such as stores, stations, and airports.

A wireless LAN network needs to be established in consideration of various factors such as construction of radio base stations, factors relating to wireless LAN communication such as parameter settings, factors relating to the network between a radio base station and a switch and between a switch and a backhaul line, and factors relating to higher level services such as user authentication and portal screens.

If a radio signal attenuates due to a propagation distance or an interrupting object in radio communication, the quality or the volume of the radio communication is usually reduced, and thus a state in which the distance between radio base stations is short and an unobstructed propagation path can be ensured is desirable. Meanwhile, because the number of radio base stations to be installed is limited due to costs incurred for equipment, installation, and operations, radio wave interference, and the like, it is important to install a required number of radio base stations at appropriate places in an area covered by a wireless LAN. Furthermore, because there is a limit on traffic and the number of users that can be accommodated by one radio base station, a movable base station using radio connections on a backhaul line may be installed within an area.

As an installation position calculation method for a movable base station, for example, NPL 2 has proposed a technique of dynamically changing the position of a base station device in accordance with variation in the user distribution in an area, and a clustering method called k-means method as disclosed in NPL 3 or the like is used to calculate an installation position of a movable base station according to a user position within an area.

### CITATION LIST

### Non Patent Literature

[NPL 1] IEEE Std 802.11-2016, December 2016.
[NPL 2] Takuto Arai, Daisuke Goto, Masashi Iwabuchi, Tatsuhiko Iwakuni, and Kazuki Maruta “AMAP: Adaptive Movable Access Point System for Offloading Efficiency Enhancement,” IEICE technical report, RCS2016-43, pp. 107-112, May. 2016.
[NPL 3] J. Macqueen, “SOME METHODS FOR CLASSIFICATION AND ANALYSIS OF MULTIVARIATE OBSERVATIONS,” Proc. of 5th Berkeley Symposium on Mathematical Statistics and Probability, pp. 281-297, 1967.

### SUMMARY OF INVENTION

### Technical Problem

When there are a plurality of movable base stations in an area, if connection destination base stations of the movable base stations are concentrated, traffic is concentrated on some base stations, and thus there is a possibility of occurrence of communication congestion.

The present disclosure aims to provide techniques by which movable base stations can be appropriately arranged.

### Solution to Problem

According to the disclosed technique, a determination method of determining an installation position of a movable base station and a connection destination base station, wherein an information processing device performs processing of determining a mesh in which the movable base station can be installed, and a base station to which the movable base station can be connected in the mesh, based on a reception strength of a radio signal from each of one or more base stations in each of one or more meshes.

### Advantageous Effects of Invention

According to the disclosed technique, movable base stations can be appropriately arranged.

### BRIEF DESCRIPTION OF DRAWINGS

FIG. 1 is a diagram showing an example of a functional configuration of an information processing apparatus 10 according to an embodiment.

FIG. 2 is a flowchart for explaining an example of processing of the information processing apparatus 10 according to an embodiment.

FIG. 3 is a diagram for describing area information according to an embodiment.

FIG. 4 is a diagram for describing mesh wireless information according to an embodiment.

FIG. 5 is a diagram for describing movable base station installation propriety information and information of connectable base stations in each mesh according to an embodiment.

FIG. 6 is a diagram for describing an example of meshes in which each movable base station according to an embodiment is installed and connectable base stations.

FIG. 7 is a diagram for describing meshes in which movable base stations according to an embodiment are arranged and determination results of base stations to which the movable base stations are connected.

FIG. 8 is a diagram for describing movable base station installation propriety information and information of connectable base stations in each mesh according to an embodiment.

FIG. 9 is a diagram for describing an example of meshes in which each movable base station according to an embodiment is installed and connectable base stations.

FIG. 10 is a flowchart for explaining an example of processing of the information processing apparatus 10 according to an embodiment when there are a plurality of base stations to which movable base stations can connect.

FIG. 11 is a diagram for describing meshes in which movable base stations according to an embodiment are arranged and determination results of base stations to which the movable base stations are connected.

FIG. 12 is a diagram showing an example of a functional configuration of the information processing apparatus 10 according to an embodiment.

### DESCRIPTION OF EMBODIMENTS

Hereinafter, embodiments of the present disclosure (the present embodiment) will be described with reference to the drawings. The embodiments described below are merely examples, and the embodiments to which the present disclosure is applied are not limited to the following embodiments.

<Functional Configuration>

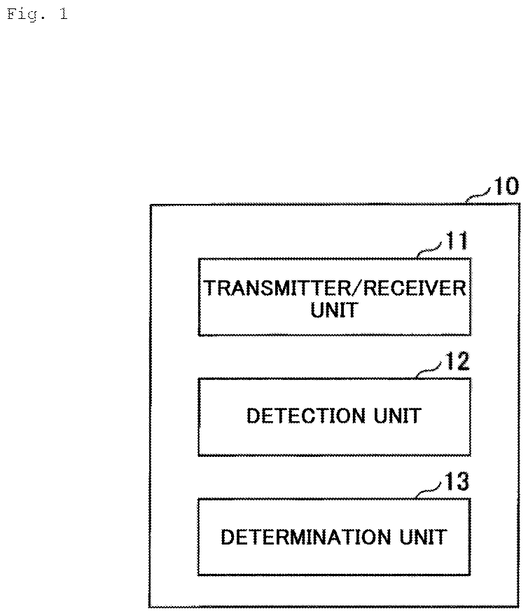

A functional configuration of an information processing apparatus 10 according to an embodiment will be described with reference to FIG. 1. FIG. 1 is a diagram showing an example of a functional configuration of the information processing apparatus 10 according to an embodiment.

In the example in FIG. 1, the information processing apparatus 10 according to the embodiment includes a transmitter/receiver unit 11, a detection unit 12, and a determination unit 13. These units may be implemented through cooperation of one or more programs installed in the information processing apparatus 10 with hardware such as a CPU of the information processing apparatus 10.

The transmitter/receiver unit 11 performs data transmission/reception with respect to external apparatuses such as a base station via a core network or the like, for example. The detection unit 12 detects predetermined information on the basis of data acquired by the transmitter/receiver unit 11. The detection unit 12 detects (acquires), for example, area information, mesh radio information, base station collection information, and the like, which will be described later. The determination unit 13 determines a position where a movable base station (a moving base station) is to be installed based on the information detected by the detection unit 12. Further, the determination unit 13 may transmit information indicating the determined position where the movable base station is to be installed to an external device to display the information.

<Processing>

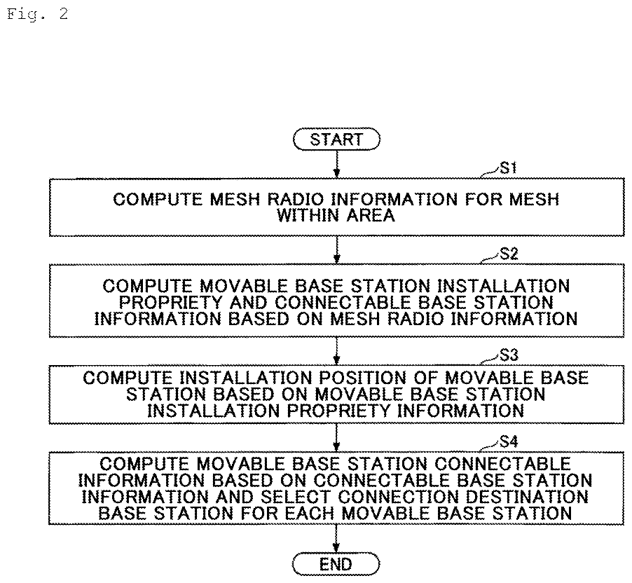

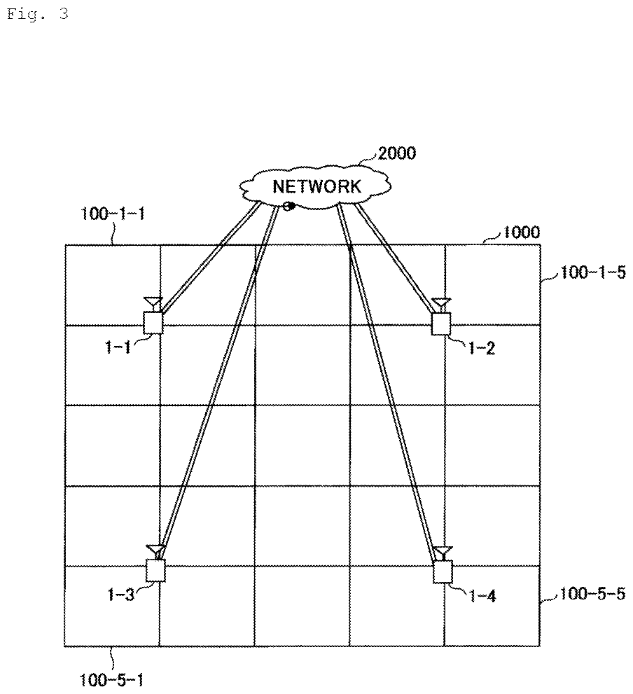

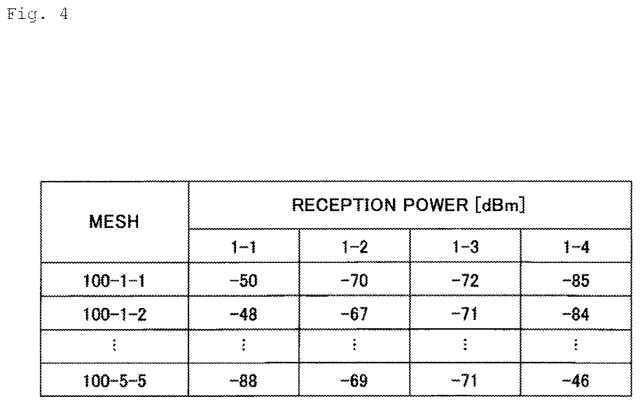

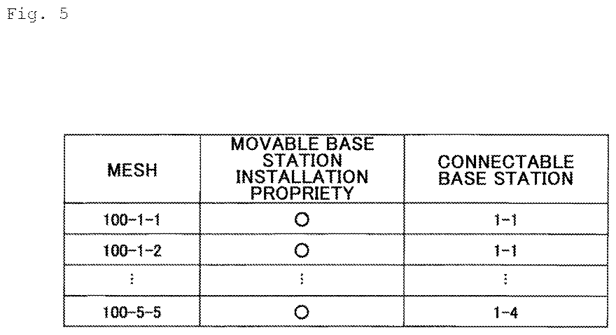

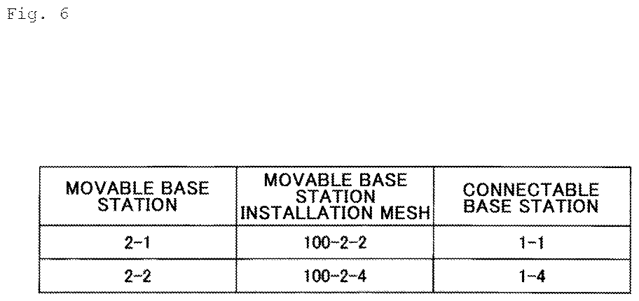

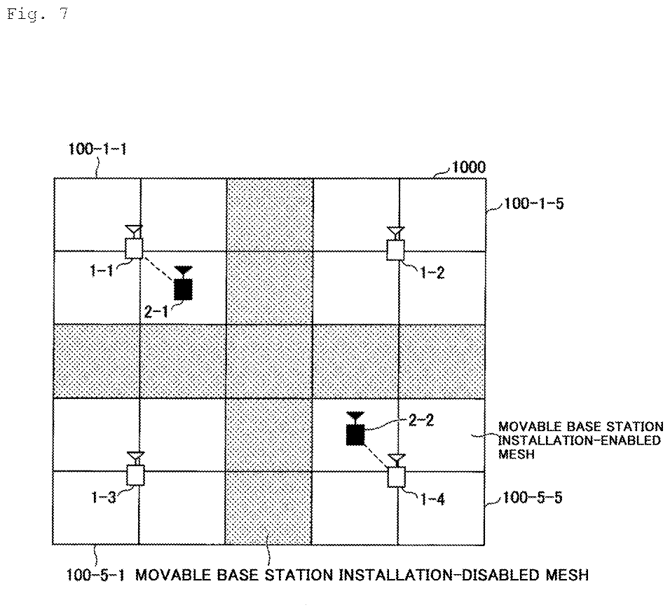

An example of processing of the information processing apparatus 10 according to an embodiment will be described with reference to FIGS. 2 to 7. FIG. 2 is a flowchart for explaining an example of processing of the information processing apparatus 10 according to an embodiment. FIG. 3 is a diagram for describing area information according to an embodiment. FIG. 4 is a diagram for describing an example of mesh radio information according to an embodiment. FIG. 5 is a diagram for describing movable base station installation propriety information and information of connectable base stations in each mesh according to an embodiment. FIG. 6 is a diagram for describing an example of meshes in which each movable base station according to an embodiment is installed and connectable base stations. FIG. 7 is a diagram for describing meshes in which movable base stations according to an embodiment are arranged and determination results of base stations to which the movable base stations are connected.

In step S1, the determination unit 13 of the information processing apparatus 10 computes (acquires), for each mesh within a predetermined area (region), mesh radio information which is information regarding the quality of radio communication in the mesh, based on area information including the area and information of base stations installed in the area.

FIG. 3 shows an example in which an area 1000 in which movable base stations are to be installed is divided into 25 meshes 100-1-1 to 100-5-5, and base stations 1-1 to 1-4 connected to a network 2000 are installed.

As shown in FIG. 4, the mesh radio information may include information indicating the reception strength of a radio signal transmitted from each of the base stations 1-1 to 1-4 in each mesh. The information indicating a reception strength of the radio signal may include, for example, at least one of a reception power indicating a power level by dBm that is the absolute value thereof in units of mW and a reception signal strength of the radio signal (Received Signal Strength Indicator or RSSI). Thus, for example, an arrangement position of a movable base station can be determined in consideration of attenuation of radio waves due to the distance from the base station or the like.

The information indicating the reception strength of the radio signal included in the mesh radio information may be set based on a value measured in advance in the area, for example. Further, the determination unit 13 may compute the information indicating the reception strength of radio signals transmitted from each of the base stations 1-1 to 1-4 in each mesh using a radio wave propagation simulation based on the area information, for example.

In step S2, the determination unit 13 computes (determines or decides) movable base station installation propriety information indicating a mesh in which a movable base station can be installed, and information of a base station connectable in each mesh based on the mesh radio information. Here, when the reception strength of a radio signal from a specific base station is greater than or equal to a threshold in a specific mesh, the determination unit 13 may determine the specific mesh as a mesh where a movable base station can be installed (a movable base station installation-enabled mesh), for example.

In the example in FIG. 5, the movable base station installation propriety information includes information indicating whether a movable base station can be installed for each mesh.

In step S3, the determination unit 13 computes (determines) a mesh (a position) in which a movable base station is to be installed based on the movable base station installation propriety information or the like. Here, the determination unit 13 may determine, for example, a mesh in which a movable base station is to be installed based on a channel use rate of each base station, the number of terminals under control of each base station, and information indicating the reception strength of a radio signal transmitted from a terminal under control of each base station. In this case, the determination unit 13 may decide to put a higher priority of installation of a movable base station to a specific movable base station installation-enabled mesh, for example, when a channel use rate of a base station connectable in the specific movable base station installation-enabled mesh becomes lower, the number of terminals under control of the base station becomes larger, and the reception strength of a radio signal transmitted from a terminal under control of the base station becomes weaker (lower). In addition, the determination unit 13 may determine a predetermined number of movable base station installation-enabled meshes as meshes for installing movable base stations in descending order of the priority.

Furthermore, the determination unit 13 may determine an installation position of a movable base station within the range of the movable base station installation-enabled mesh. In this case, for example, the determination unit 13 may first temporarily set (temporarily install) a movable base station at a certain installation place regardless of the movable base station installation propriety information. In this case, the determination unit 13 may temporarily determine each movable base station based on, for example, the number of terminals accommodated by each base station, the reception strength of a radio signal transmitted from the terminal accommodated by each base station to each base station, or the like.

Then, for example, when the installation place is included in a mesh in which no movable base station can be installed (a movable base station installation-disabled mesh), the determination unit 13 may move the installation place to the closest mesh among the movable base station installation-enabled meshes.

In step S4, the determination unit 13 determines a base station to be connected as a backhaul line for each movable base station whose installation place has been determined based on the information of the base station connectable in each mesh computed in step S2. Here, the determination unit 13 may determine a base station to be connected among a plurality of base stations connectable in each mesh in which each movable base station is to be installed based on the channel use rate of each base station, the number of terminals under control of each base station, and information indicating the reception strength of a radio signal transmitted from a terminal under control of each base station. In this case, the determination unit 13 may decide to put a higher priority of selection of a base station as a connection destination, for example, when a channel use rate of the base station connectable in the specific movable base station installation-enabled mesh becomes lower, the number of terminals under control of the base station becomes larger, and the reception strength of a radio signal transmitted from a terminal under control of the base station becomes weaker (lower). Then, the determination unit 13 may determine a base station to which each movable base station is connected as a backhaul line based on the priority.

The example in FIG. 6 shows that a movable base station 2-1 is installed in a mesh 100-2-2, and can be connected to the base station 1-1, and the like.

As a result, meshes in which the movable base stations are installed and the base station to which the movable base stations are connected are determined as shown in FIG. 7. The example in FIG. 7 shows that the movable base station 2-1 is installed in the mesh 100-2-2, and can be connected to the base station 1-1, and the like.

<<Processing in Case where there are Plurality of Connectable Base Stations>>

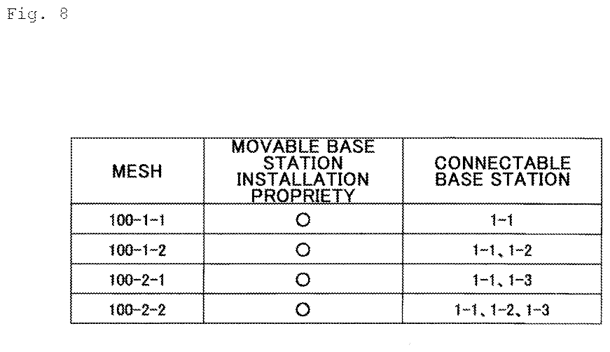

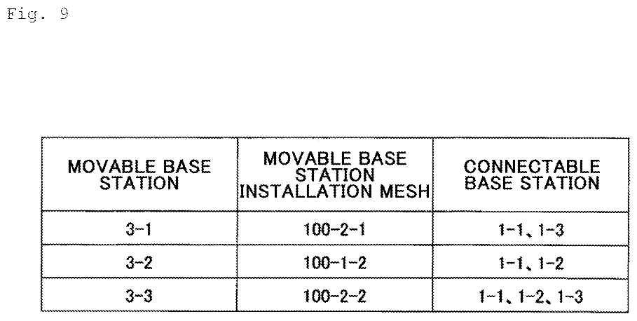

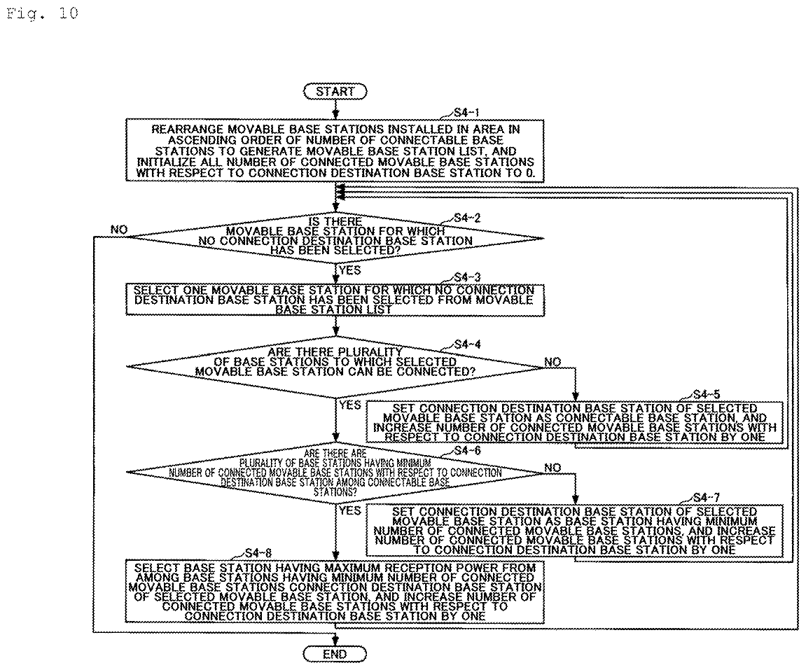

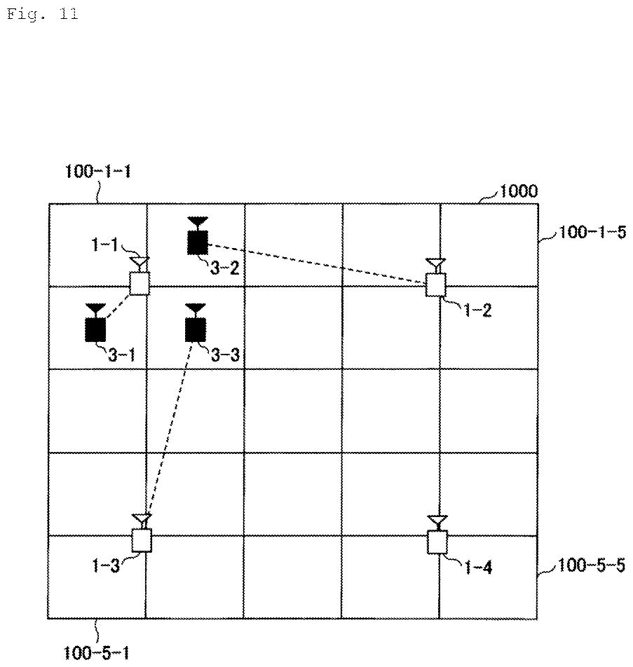

Next, referring to FIGS. 8 to 11, an example of processing when there are a plurality of base stations to which movable base stations can be connected in the step S4 of FIG. 2 will be described. FIG. 8 is a diagram for describing movable base station installation propriety information and information of base stations connectable in each mesh according to an embodiment. FIG. 9 is a diagram for describing an example of meshes in which each movable base station according to an embodiment is installed and connectable base stations. FIG. 10 is a flowchart for explaining an example of processing of the information processing apparatus 10 according to an embodiment when there are a plurality of base stations to which movable base stations can be connected. FIG. 11 is a diagram for describing meshes in which movable base stations according to an embodiment are arranged and determination results of base stations to which the movable base stations are connected.

Hereinbelow, it will be assumed in step S2 of FIG. 2 that the determination unit 13 has computed movable base station installation propriety information indicating whether a movable base station can be installed for each mesh and information of a base station connectable in each mesh as shown in FIG. 8 based on the mesh radio information, for the sake of description. The example of FIG. 8 shows that the movable base station installed in the mesh 100-1-1 can be connected to the base station 1-1, the movable base station installed in the mesh 100-1-2 can be connected to either of the base station 1-1 or the base station 1-2, the movable base station installed in the mesh 100-2-1 can be connected to either of the base station 1-1 or the base station 1-3, and the movable base station installed in the mesh 100-2-2 can be connected to any one of the base station 1-1, the base station 1-2, and the base station 1-3.

In addition, in step S4 of FIG. 2, the determination unit 13 determines a mesh in which each movable base station is to be installed, and a connectable base station as shown in FIG. 9. The example in FIG. 9 shows that a movable base station 3-1 is installed in the mesh 100-2-1 and can be connected to either of the base station 1-1 or the base station 1-3. In addition, it is shown that a movable base station 3-2 is installed in the mesh 100-1-2, and can be connected to either of the base station 1-1 or the base station 1-2. In addition, it is shown that a movable base station 3-3 is installed in the mesh 100-2-2 and can be connected to any one of the base station 1-1, the base station 1-2, and the base station 1-3.

As shown in FIG. 10, in step S4-1, the determination unit 13 rearranges movable base stations installed in an area in ascending order of the number of connectable base stations to generate a movable base station list, and initializes every number of connected movable base stations with respect to a connection destination base station to 0.

Then, the determination unit 13 determines whether there is a movable base station for which no connection destination base station has been selected (step S4-2), and if there is none (NO in step S4-2), the determination unit 13 ends the processing.

On the other hand, if there is a movable base station for which no connection destination base station has been selected (YES in step S4-2), the determination unit 13 selects one movable base station for which no connection destination base station has been selected from the movable base station list (step S4-3).

Then, the determination unit 13 determines whether there are a plurality of base stations to which the selected movable base station can be connected (step S4-4).

If there are not a plurality of connectable base stations (NO in step S4-4), the determination unit 13 sets a connection destination base station of the selected movable base station as a connectable base station, increases the number of connected movable base stations with respect to the connection destination base station by one (step S4-5), and proceeds to the processing of step S4-2.

On the other hand, if there are a plurality of connectable base stations (YES in step S4-4), the determination unit 13 determines whether there are a plurality of base stations having the minimum number of connected movable base stations with respect to the connection destination base station among the connectable base stations (step S4-6).

If there are not a plurality of base stations having the minimum number of connected movable base stations (NO in step S4-6), the determination unit 13 sets a connection destination base station of the selected movable base station as a base station having the minimum number of connected movable base stations, increases the number of connected movable base stations with respect to the connection destination base station by one (step S4-7), and proceeds to the processing of step S4-2.

On the other hand, if there are a plurality of base stations having the minimum number of connected movable base stations (YES in step S4-6), the determination unit 13 selects a base station having the maximum reception power from among the base stations having the minimum number of connected movable base stations as a connection destination base station of the selected movable base station, and increases the number of connected movable base stations with respect to the connection destination base station by one (step S4-8).

Thus, the connection destination base station of each movable base station can be selected. FIG. 11 shows a connection destination base station of each movable base station determined in the processing of FIG. 10 in the cases shown in FIGS. 8 and 9 described above. The example in FIG. 11 shows that the movable base station 3-1 is installed in the mesh 100-2-1 and connected to the base station 1-1, the movable base station 3-2 is installed in the mesh 100-1-2 and connected to the base station 1-2, and the movable base station 3-3 is installed in the mesh 100-2-2 and connected to the base station 1-3.

Further, the movable base stations may be, for example, base stations mounted on a vehicle (a moving base station vehicle), a portable base station for communicating with a core network via a satellite, or the like.

Further, for example, it is considered that a movable base station corresponding to the latest standard may be additionally installed in an area where base stations based on a legacy standard have been installed. In this case, in a case where a base station installed close to a movable base station has a function of steering (instructing a connection destination) with respect to a terminal under control, communication can be efficiently performed by steering the terminal under control toward the movable base station, so as to be connected to the movable base station according to the radio standard of the terminal.

<Effects of Present Disclosure>

Because movable base stations use radio connection on a backhaul line, for example, the radio quality of the backhaul line deteriorates depending on a position where a movable base station is installed.

In addition, when there are a plurality of movable base stations within an area, if the connection destinations of a plurality of movable base stations are concentrated in specific base stations, there is a possibility of occurrence of congestion in communication.

According to the techniques of the present disclosure described above, it is possible to appropriately determine an installation position of a movable base station and a connection destination base station in consideration of the radio quality of the backhaul line.

(Other Configuration Examples)

The functions of the respective functional blocks of the information processing apparatus 10 shown in FIG. 1 may be implemented by dedicated hardware (LSI chips or the like), or by a general-purpose computer having a processor (a CPU, a DSP, or the like) and a memory, and software operating on the computer.

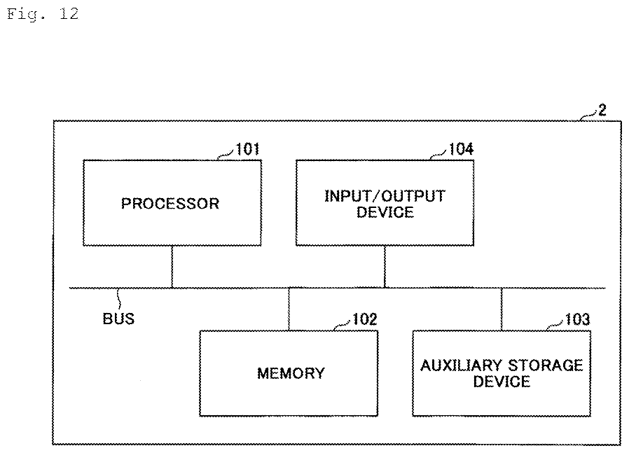

FIG. 12 shows an example of a configuration of the information processing apparatus 10 when the information processing apparatus 10 is implemented by using a computer and software.

The information processing apparatus 10 includes a processor 101, a memory 102, an auxiliary storage device 103, and an input/output device 104, and these are connected by a bus as shown in FIG. 12.

For example, a program for implementing the processing of the information processing apparatus 10 is stored in the auxiliary storage device 103 (a computer-readable recording medium). When the information processing apparatus 10 operates, the program is read into the memory 102, and the processor 101 reads the program from the memory 102 and executes it. For example, the processor 101 executes the processing of the determination unit 13 or the like according to the program.

In addition, the “computer-readable recording medium” is, for example, a portable medium such as a flexible disk, a magneto-optical disk, a ROM, or a CD-ROM, a hard disk built into a computer system, or the like. In addition, the “computer-readable recording medium” may also include a recording medium that dynamically retains a program for a short period of time like a communication line such as the Internet or a communication line such as a telephone line and a recording medium that retains a program for a certain period of time like a volatile memory inside the computer system that serves as a server or a client in that case.

Although the embodiments have been described above, the present invention is not limited to such specific embodiments, and various modifications and changes can be made within the scope of the gist of the present invention described in the claims.

### REFERENCE SIGNS LIST

10 Information processing apparatus
11 Transmitter/receiver unit
12 Detection unit
13 Determination unit
1-1 to 1-4 Base station
2-1 to 2-2 Movable base station
101 Processor
102 Memory
103 Auxiliary storage device
104 Input/output device
1000 Area
2000 Network

1. A determination method of determining an installation position of a movable base station and a connection destination base station, executed by an information processing device including a memory and a processor, the determination method comprising:
determining a mesh in which the movable base station can be installed, and a base station to which the movable base station can be connected in the mesh, based on a reception strength of a radio signal from each of one or more base stations in each of one or more meshes.

2. The determination method according to claim 1, wherein, in the determining, among meshes in which the movable base station can be installed as determined based on the reception strength of the radio signal from each of the one or more base stations in each of the one or more meshes, and
wherein the mesh in which the movable base station is to be installed is determined based on at least one of a channel use rate of each of the one or more base stations, a number of terminals under control of each of the one or more the base stations, and information indicating a reception strength of a radio signal transmitted from a terminal under control of each of the one or more the base stations.

3. The determination method according to claim 1, wherein, in the determining, among base stations to which the movable base station can be connected in the mesh in which the movable base station is to be installed, the base station to which the movable base station is to be connected is determined based on at least one of a channel use rate of the base station, a number of terminals under control of the base station, and information indicating a reception strength of a radio signal transmitted from a terminal under control of the base station.

4. The determination method according to claim 1, wherein, in the determining, among base stations to which a plurality of movable base stations can be connected in the mesh in which the movable base station is to be installed, a base station having a smaller number of movable base stations being connected is determined as the base station to which the specific movable base station is connected.

5. An information processing apparatus comprising:
a memory; and
a processor configured to determine a mesh in which a movable base station can be installed, and a base station to which the movable base station can be connected in the mesh, based on a reception strength of a radio signal from each of one or more base stations in each of one or more meshes.
